(19) United States
(12) Patent Application Publication
(10) Pub. No.: US 2015/0144247 A1
(43) Pub. Date: May 28, 2015

(54) METHOD FOR MANUFACTURING WINDING PARTS FOR AN ELECTRIC MACHINE

(71) Applicant: ALSTOM Technology Ltd, Baden (CH)

(72) Inventors: Erminio MERATI, Lissone (IT); Giorgio Torre, Monza (IT); Massimiliano Visintin, Zürich (CH); Paolo Maggioni, Vimodrone (IT)

(21) Appl. No.: 14/609,789

(22) Filed: Jan. 30, 2015

Related U.S. Application Data
(63) Continuation of application No. PCT/EP2013/065686, filed on Jul. 25, 2013.

(30) Foreign Application Priority Data
Aug. 3, 2012 (EP) 12425134.9

(51) Int. Cl. H02K 3/32; H01B 13/06; B29C 33/38

(52) U.S. Cl. CPC H02K 3/32; B29C 33/3842; H01B 13/06
USPC 156/52; 264/225

(57) ABSTRACT

The disclosure refers to a method for manufacturing winding parts for an electric machine. The winding parts include a conductor and insulation around it. The method includes providing the conductor with an insulating tape around it, providing dies above the insulating tape, providing a thermosetting layer around the dies, impregnating the insulating tape with a resin, curing the resin to realise the insulation, removing the thermosetting layer and the dies.

### CROSS-REFERENCE TO RELATED APPLICATIONS

This application claims priority to PCT/EP2013/065686 filed Jul. 25, 2013, which claims priority to European application 12425134.9 filed Aug. 3, 2012, both of which are hereby incorporated in their entireties.

### TECHNICAL FIELD

The present disclosure relates to a method for manufacturing winding parts for an electric machine.

The electric machine can be a rotating electric machine such as a synchronous generator to be connected to a gas or steam turbine (turbogenerator) or a synchronous generator to be connected to a hydro turbine (hydro generator) or an asynchronous generator or a synchronous or asynchronous electric motor or also other types of electric machines.

### BACKGROUND

Electric machines such as those described above have a stator and a rotor.

The stator has a laminated stator core with slots housing bars.

The rotor has a massive or laminated core with slots also housing bars. Shafts extend from each side of the core.

The configuration described is the typical one, but also other configurations are possible.

The bars (stator bars) have a straight part (that is housed in the slots) and end windings, which have a complex form and are located outside of the slots, around the shafts. The bars are connected together to define windings.

The windings described above are generally connected to phase rings which lead to the generator terminals.

Different methods for manufacturing the winding parts, such as bars, phase connections, etc., exist.

In a typical example of a manufacturing process of a winding part such as a bar, a conductor is wrapped with a mica tape, then its straight part is housed in a frame and the end windings are pressed within an additional tool.

Thus the mica tape is impregnated with a resin and the resin is then cured to realise the insulation.

This method proved to be efficient, but the inventors found a way to further improve it.

In fact during curing the bar is pressed to get rid of the excess of resin. Pressing is achieved by a thermoshrinkable tape that is wrapped around the bar.

However when pressing the bars, since the bar cross section is usually rectangular or square, it is difficult to apply a uniform pressure simply by the thermoshrinkable tape. This strongly influences the quality of the insulation.

The same issue is encountered when bar-to-phase rings are manufactured (generally onsite in case of machine rewinds or repairs).

Similar issues can also be found when manufacturing other stator winding parts as well as rotor windings.

### SUMMARY

An aspect of the disclosure includes providing a method by which the pressure applied to the winding parts during manufacturing is more uniform than with the existing methods.

These and further aspects are attained by providing a method in accordance with the accompanying claims.

Advantageously, the present method allows to get a precise shape for the pressing tool without requiring a specific and expensive tool machining and adaptation.

### BRIEF DESCRIPTION OF THE DRAWINGS

Further characteristics and advantages will be more apparent from the description of a preferred but non-exclusive embodiment of the method, illustrated by way of non-limiting example in the accompanying drawings, in which:

FIGS. 1 and 2 show a bar;

FIG. 3 shows a conductor with an insulating tape;

FIGS. 4 and 5 show a conductor with an insulating tape housed in a frame;

FIGS. 6 and 7 show an end winding with mouldable material elements;

FIGS. 8 and 9 show an end winding with mouldable material elements and a thermosetting layer (respectively before and during vulcanization);

FIGS. 10 and 11 show an end winding with dies and a thermosetting layer;

FIGS. 12 and 13 show an end winding with dies and a thermosetting layer during insulating tape impregnation;

FIG. 14 shows a bar;

FIG. 15 shows an electric machine (in particular a part thereof) such as a stator;

FIGS. 16 and 17 show an old bar with a conductor and an old insulation;

FIG. 18 shows a conductor of the old bar from which the old insulation has been removed;

FIG. 19 shows the conductor of the old bar with a new insulating tape; and

FIG. 20 shows a bar-to-phase connection.

### DETAILED DESCRIPTION

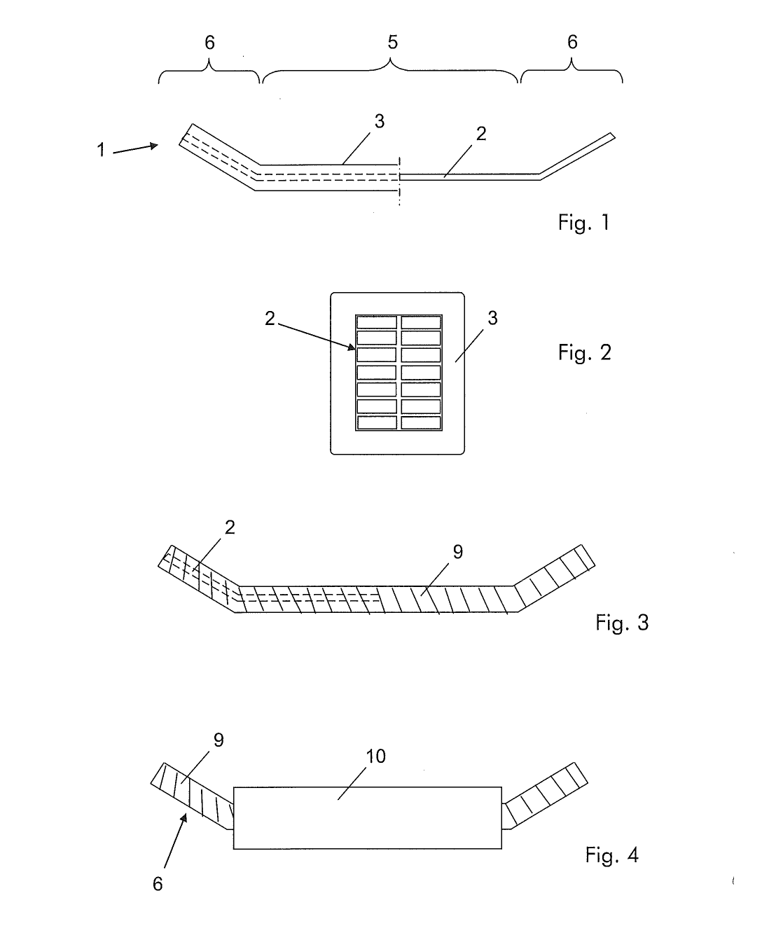

FIGS. 1 and 2 show winding parts 1 such as bars (in particular these figures show stator bars, but these bars could also be rotor bars or other stator and/or rotor winding parts), realised according to the present method.

The bar 1 has a conductor 2 that can be a massive conductor (i.e. a single element) or a transposed conductor made of a plurality of transposed strands.

Around the conductor 2 insulation 3 is provided.

The conductor 2, the insulation 3 and the bar 1 define a rectangular or square cross section.

The conductor 2 and the bar 1 have a straight part 5 and end windings 6 extending from the straight part 5 with a complex form, for them to be connected to a bar at an opposite stator part or to the phase connections.

The method includes providing the conductive element 2 with at least an insulating tape 9 around it (FIG. 3). The insulating tape 9 is usually a mica tape, such as a tape having a support layer (for example glass fibre layer) and a mica layer.

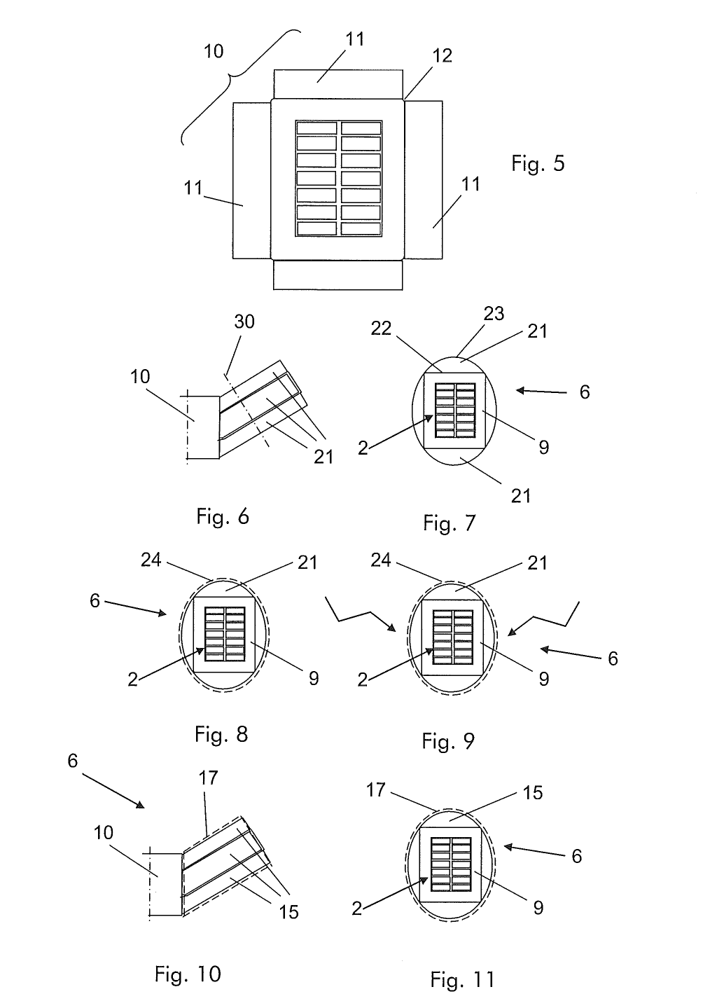

Then a frame 10 can be provided around the straight part 5 (FIGS. 4, 5). FIGS. 4 and 5 show an example of a frame 10 that can be used. The frame 10 uniformly presses the mica tape 9 with a precise pressure. The frame 10 can be defined by metal plates 11 with gaps 12 between each other over their longitudinal adjacent borders; these gaps 12 help impregnation.

Thus, the method includes providing dies 15 above the mica tape 9, preferably (but not necessarily only) at the end windings 6; according to the particular cross section of the winding parts such as bars one or more dies 15 can be provided above the mica tape 9, for example a plurality of dies around the mica tape (i.e. around the cross section of the winding part) can be provided. Thus a thermosetting layer 17 is provided around the dies 15 (FIGS. 10 and 11).

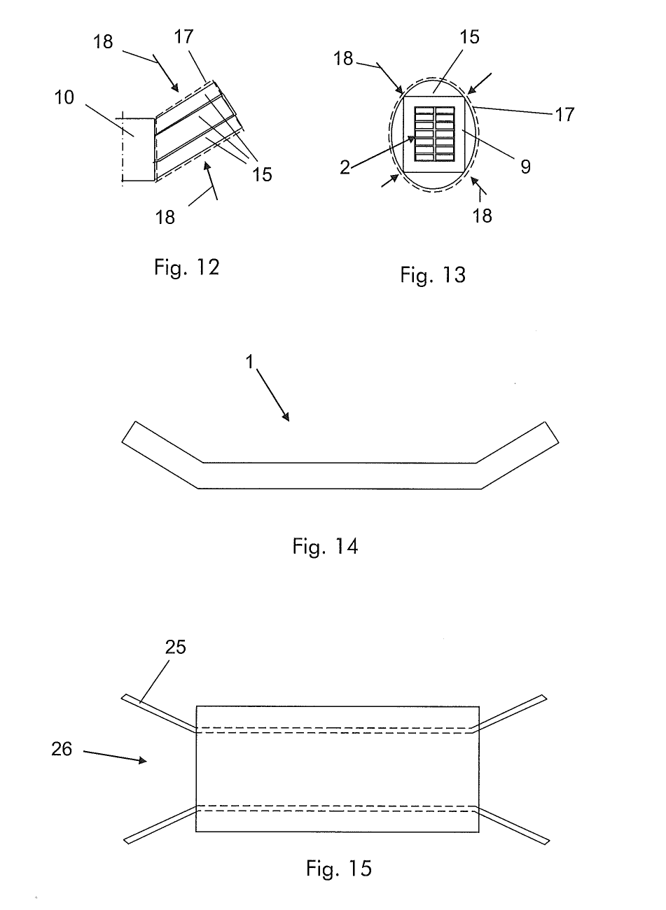

Thus the method includes impregnating the insulating tape 9 with a resin 18 (FIGS. 12 and 13) and curing the resin 18 to realise the insulation 3. Curing preferably includes heating the resin 18 at a temperature between 110-130° C.

Finally, the thermosetting layers 17, the dies 15 and the frame 10 are removed from the bar 1 (FIG. 14).

The step of providing the dies 15 can be carried out in different ways.

In a first example the dies 15 can be already available, because for example they are manufactured on the basis of drawings of the bars or die themselves.

In a second example the dies 15 can be available because they have already been manufactured according to the method described in the following (third example).

In a third example, providing the dies 15 includes providing a mouldable material at the at least a bar end winding 6 or sample thereof, preferably at each side of the bar end winding 6 or sample thereof, and then shaping the mouldable material (FIGS. 6 and 7).

The mouldable material can be an un-vulcanised plastic material or un-vulcanised rubber, such as chloroprene strips.

This material in the un-vulcanized state can be adapted to get the required shape, whereas after vulcanization it acquires the desired stiffness thus allowing to evenly distribute the pressure over the bar surface.

Shaping includes realising mouldable material elements 21 each having a wall 22 reproducing the shape of the bar end winding 6, for example plain (preferably reproducing the shape of a part of the surface of the bar at the end winding 6) or a sample thereof, and a wall 23 defining a curved sector.

Preferably, a mouldable material element 21 is defined at each side of the end windings 6 or sample thereof, and each mouldable material element 21 is a separate element from the other mouldable material elements 21.

In addition, the curved sectors of the mouldable material elements 21 located in planes 30 perpendicular to the bar end winding 6 or sample thereof preferably define a circle or an elliptical or ovoid shape.

Thus according to the method the mouldable material elements 21 are cured or vulcanised to realise the dies 15 (FIGS. 9).

vulcanizing the mouldable material elements 21 includes heating the mouldable material elements 21 at a temperature between 140-160° C. for example in an oven.

In addition, a thermosetting layer 24 can be provided around the mouldable material elements 21 before they are vulcanized; the thermosetting layer 24 can be removed after vulcanization (FIGS. 9, 10).

Different ways are available to provide the conductor 2.

For example the conductor 2 can be manufactured on the basis of drawings or in other ways.

Alternatively, a conductor 2 removed from an existing machine can be used.

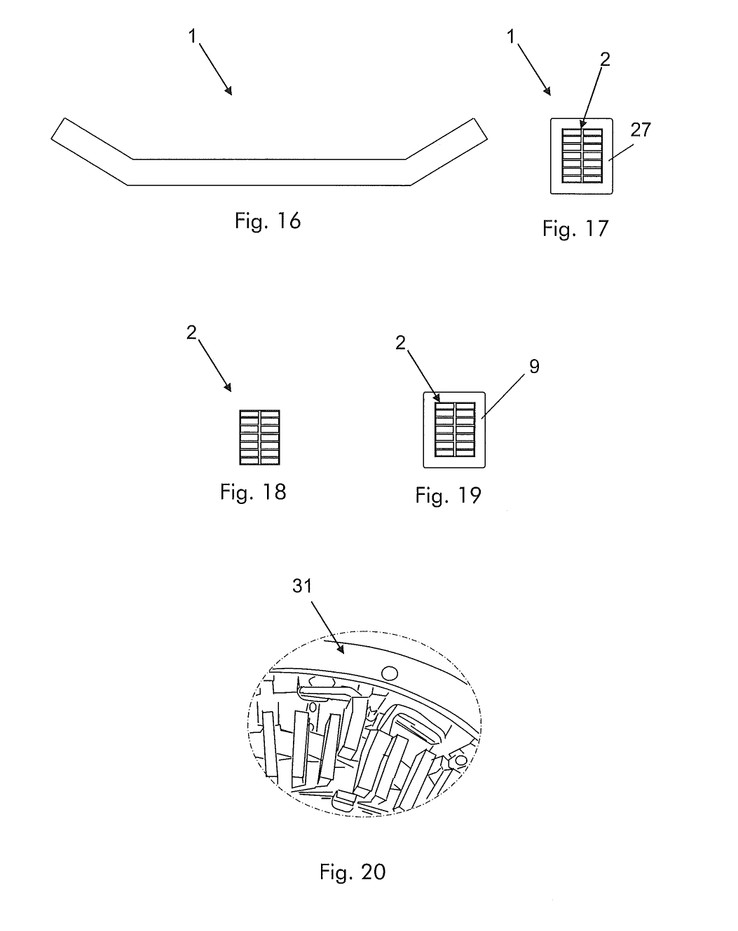

In this case an old bar 25 is removed from an electric machine 26, the old bar 25 having the conductor 2 and old insulation 27 around it. Thus the old insulation 27 is removed from the conductor 2 and an insulating tape 9 is provided around the conductive element 2 FIGS. 15-19).

The method using mouldable materials such as un-vulcanized rubber can also be applied when manufacturing the straight part of the bar, i.e. the dies 15 realised with mouldable material can replace the frames as well if needed.

In addition, the dies 15 realised with mouldable material can be used to manufacture the connections between bars and phase rings and also to manufacture the phase rings. Also in these cases it is required to press the components to get rid of the resin excess, but at the same time to follow the component shape as close as possible, so as to uniformly distribute the pressure. For example FIG. 20 shows a bar-to-phase connection 31.

The method described can be used in a number of cases; some of these cases are described in the following.

### EXAMPLE 1

The method can be used to manufacture bar or other winding parts for new machines. In this case the conductors 2 and dies 15 are manufactured on the basis of drawings.

### EXAMPLE 2

The method can be used to manufacture bars or other winding parts for new machines, but in this case the conductors 2 are manufactured on the basis of drawings and the dies 15 are manufactured using the mouldable material according to the process described above.

### EXAMPLE 3

The method is used to manufacture bars or other winding parts for existing machines. In this case the original bars or other winding parts are removed from the electric machine and new conductors 2 are provided (they are for example realised on the basis of drawings). The dies 15 can be then realised on the basis of drawings.

### EXAMPLE 4

Also in this case the method is used to manufacture bars or other winding parts for existing machines. In this case the original bars or other winding parts are removed from the electric machine and are used to realise the dies using the mouldable material according to the process described above. Then the original insulation 27 is removed from the conductor 2 and a mica tape is wrapped around the conductor 2.

### METHOD

The present disclosure also refers to a method for manufacturing a die 15 for winding parts for an electric machine.

The method comprises:
providing at least a winding part or sample thereof, then
providing mouldable material at at least a side of the winding part or sample thereof, then
shaping the mouldable material when it is the un-vulcanized state to define at least a mouldable material element 21, then
vulcanizing the mouldable material element 21 to realise at least a die 15, then
removing the at least a die 15 from the winding part or sample thereof.

For example shaping includes realising mouldable material elements 21 having a wall 22 reproducing at least a part of the shape of the winding part or sample thereof, and a wall 23 defining a curved sector.

Preferably, a mouldable material element 21 is defined at each side of the winding part or sample thereof (such as end winding 6), each mouldable material element 21 being a separate element from the other mouldable material elements 21.

In addition, the curved sectors defined by each wall 23 of the mouldable material elements 21 located in planes perpendicular to the winding part or sample thereof (such as end winding 6) define a circle or elliptical or ovoid shape.

Vulcanizing includes heating the mouldable material elements 21 at a temperature between 140-160° C.

The sample can be defined by the winding parts (for example end windings) that have been cut or removed in any other way from the winding of a machine. Alternatively the sample can be realised on the basis of measures taken from a winding of a machine or drawings.

Naturally the features described may be independently provided from one another.

In practice the materials used and the dimensions can be chosen at will according to requirements and to the state of the art.

1. A Method for manufacturing winding parts for an electric machine, the winding parts including a conductor and insulation around it, the method including:
providing the conductor with an insulating tape around it,
providing dies above the insulating tape,
providing a thermosetting layer around the dies,
impregnating the insulating tape with a resin,
curing the resin to realise the insulation, and
removing the thermosetting layer and the dies.

2. The method of claim 1, wherein the winding parts include at least a bar, the bar having a straight part and end windings at the ends of the strait part, the method further including providing a frame around the straight part and providing the dies at the end windings.

3. The method of claim 1, wherein the winding parts include at least a phase connection and/or a phase ring.

4. The method of claim 1, wherein curing the resin includes heating the resin at a temperature between 110-130° C.

5. The method of claim 1, wherein the providing the dies includes:
providing mouldable material at at least a side of the winding parts or sample thereof, then
shaping the mouldable material to define mouldable material elements, then
vulcanizing the mouldable material elements to realise the dies.

6. The method of claim 5, wherein shaping includes realising at least one mouldable material element having:
a wall reproducing the shape of a winding part or sample thereof, and
a wall defining a curved sector.

7. The method of claim 5, further comprising defining a mouldable material element at each side of a winding part or sample thereof, each mouldable material element being a separate element from the other mouldable material elements.

8. The method of claim 6, wherein the curved sectors of the mouldable material elements located in planes perpendicular to a winding part or sample thereof define a circle or an elliptical or ovoid shape.

9. The method of claim 5, wherein the vulcanizing the mouldable material elements includes heating the mouldable material elements at a temperature between 140-160° C.

10. The method of claim 5, further comprising:
providing a thermosetting layer around the mouldable material elements before they are vulcanized, and removing the thermosetting layer after vulcanization.

11. The method of claim 1, wherein the providing a conductor with an insulating tape around it includes:
removing an old bar from an electric machine, the old bar having the conductor and old insulation around it,
removing the old insulation from the conductor,
providing an insulating tape around the conductor.

12. A method for manufacturing a die for winding parts according to claim 1.

13. A method for manufacturing a die according to claim 12, the method comprising:
providing at least a winding part or a sample thereof, then
providing mouldable material at at least a side of the winding part or sample thereof, then
shaping the mouldable material to define at least a mouldable material element, then
vulcanizing the mouldable material element to realise at least a die, then
removing the at least a die from the at least a winding part or sample thereof.

14. The method of claim 13, wherein the shaping includes realising at least a mouldable material element having:
a wall reproducing at least a part of the shape of the at least a winding part or sample thereof,
a wall defining a curved sector.

15. The method of claim 13, further comprising defining a mouldable material element at each side of the winding part or sample thereof, each mouldable material element being a separate element from the other mouldable material elements.

16. The method of claim 14, wherein the curved sectors of the mouldable material elements located in planes perpendicular to the winding part or sample thereof define a circle or an elliptical or ovoid shape.
